(19) United States
(12) Patent Application Publication
(10) Pub. No.: US 2010/0033708 A1
(43) Pub. Date: Feb. 11, 2010

(54) Optical Inspection System Using UV Light for Automated Inspection of Holograms

(76) Inventor: Michael H. Kriz, Duncan, SC (US)

Correspondence Address: DORITY & MANNING, P.A., POST OFFICE BOX 1449, GREENVILLE, SC, 29602-1449, US

(21) Appl. No.: 12/189,351

(22) Filed: Aug. 11, 2008

(51) Int. Cl. G01N 21/88

(52) U.S. Cl. 356/51; 356/237.2

(57) ABSTRACT

Disclosed is an apparatus and methodology for inspecting holograms for structural integrity. Holograms configured for image formation under ambient, humanly perceivable light are illuminated with ultra-violet (UV) light to obtain an image of the actual structure of the hologram. The UV image is compared to a master hologram or image data file to determine the structural integrity.

### FIELD OF THE INVENTION

The present subject matter relates to post manufacturing product inspection. More specifically, the present subject matter relates to automatic testing of holograms for errors and defects.

### BACKGROUND OF THE INVENTION

The use of holographic images is becoming more prevalent in many areas of commerce. The use of such images has become especially associated with security markings on various items including bank notes, credit cards, identity cards, and other similar items having associated therewith aspects of secure and authentication.

U.S. Pat. No. 7,129,709 to Puttkammer discloses a method of testing documents provided with optico-diffractively effective markings or holograms where portions of the hologram are interspersed with electromagnetic radiation sensitive elements, for example, a fluorescent dye to authenticate the hologram.

U.S. Pat. No. 7,262,604 to Puttkammer discloses a method of testing documents provided with optico-diffractively effective markings or holograms where the structure to be tested is capacitively coupled to a security indicium and a signal derived from the capacitive coupling is compared against a stored signal.

While such additional testing of portions of additives to holograms is certainly useful, it would be highly beneficial to be able to easily test the holographic image itself.

As with any manufactured item, it is often necessary to test the item prior to use or sale to insure specified criteria are met. Various forms of such testing of holograms have been devised but are often complicated and may not provide adequate results. It will be appreciated by those of ordinary skill in the art that visual inspection of holograms using light sources selected to operate in conjunction with the particular hologram to reproduce a holographic image contained within the hologram is difficult at best simply because of the variation in image appearance due to changes in both the inspection angle as well as the illumination angle. It would be preferable to provide a method and system that avoided such angle dependencies.

While various implementations of holographic imaging systems have been developed, and while various authentication and verification systems have been developed, no design has emerged that generally encompasses all of the desired characteristics as hereafter presented in accordance with the subject technology.

### SUMMARY OF THE INVENTION

In view of the recognized features encountered in the prior art and addressed by the present subject matter, an improved methodology for automatic testing of holograms has been developed.

In an exemplary configuration, a method of inspecting a hologram has been developed wherein a hologram that has been configured to generate a holographic image when viewed under visible light is illuminated with non-visible radiation. Non-visible radiation scattered from the hologram is collected to form an image of the holographic structure which image is then analyzed to determine the presence of any malformations within the structure.

Another positive aspect of this type of device is that the illuminating source is removed in wavelength a sufficient distance such that a holographic image is not produced by the illuminating source so that an actual image of the holographic structure is produced without the interference patterns normally associated with holographic image reproduction. In one of its simpler forms, an ultra-violet (UV) radiation source may be used to illuminate the hologram. In particular embodiments, ultra-violet radiation at approximately 395 nm wavelength may be provide as the illumination source and may be generated by one or more light emitting diode (LED) devices.

In accordance with aspects of certain embodiments of the present subject matter, a holographic structure may be associated with a piece of currency or a bank note.

According to yet still other aspects of additional embodiments of the present subject matter, a system has been developed to inspect holograms wherein at least one UV light source is configured to illuminate at least one holographic structure carried by an item. An imaging system is provided to collect UV light scattered from the holographic structure and to generate a UV image of the holographic structure. At least one computing device is provided and configured to analyze the UV image in order to determine whether the holographic structure is properly formed.

In accordance with yet still further aspects of still further embodiments of the present subject matter, the system is configured to compare the UV image to a reference or master pattern. In additional exemplary embodiments the reference or master pattern may correspond to a physical master hologram while in yet still other exemplary embodiments the reference or master hologram may correspond to a data file containing a representation of the master hologram.

Additional objects and advantages of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a pictorial representation of a hologram inspection system in accordance with present technology; and

FIG. 2 is a flow chart representation of a method of inspecting holograms in accordance with present technology.

Repeat use of reference characters throughout the present specification and appended drawings is intended to represent same or analogous features or elements of the invention.

### DETAILED DESCRIPTION OF THE PREFERRED EMBODIMENTS

As discussed in the Summary of the Invention section, the present subject matter is particularly concerned with inspection of holographic structures to determine whether errors or defects are present in the structure.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

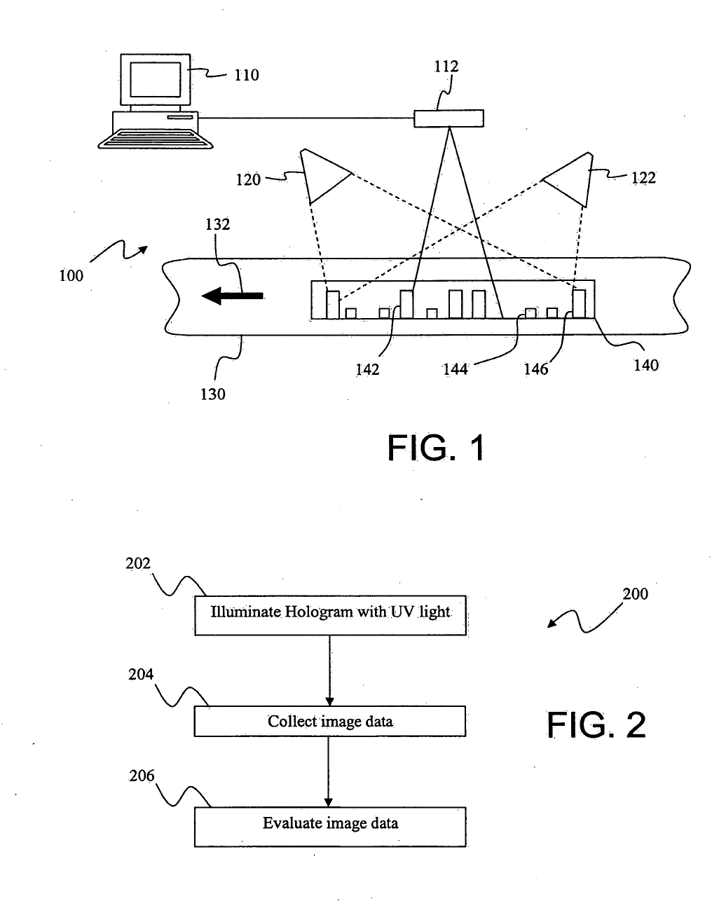

Reference will now be made in detail to the presently preferred embodiments of the subject optical inspection system. Referring now to the drawings, FIG. 1 illustrates a pictorial representation of a hologram inspection system 100 in accordance with present technology. As illustrated in FIG. 1, inspection system 100 corresponds in part to a computer 110 coupled to a camera 112. Camera 112 may include a charge coupled device (CCD) image sensor that is sensitive at least to the ultra-violet wavelength spectrum. Computer 110 may be any suitable general-purpose computer operating under suitable software to direct optical inspection system 100 to operate in accordance with the inspection methodologies of the present technology as will be described later. Those of ordinary skill in the art should appreciate that computer 110 may also correspond to a special purpose computer specifically designed to operate in a manner similar to the previously noted general-purpose computer.

Optical inspection system 100 also includes one or more illumination devices 120, 122 configured to illuminate at least a portion of hologram 140 affixed to or transported by item 130. In an exemplary configuration, illumination device 120, 122 may correspond to one or more ultra-violet (UV) light emitting diodes (LED). In particular embodiments, illumination device 120, 122 may correspond to LEDs emitting UV radiation at approximately 395 nm. Those of ordinary skill in the art will certainly appreciate, however, that such a specific wavelength is not necessary for the operation of the present subject matter. Thus the exact wavelength of illumination radiation may vary. The important aspect of the illuminating radiation is that such radiation is removed in wavelength a sufficient distance from the visible light spectrum for which the hologram was designed to operate such that holographic images are not produced by the hologram under test upon illumination with illumination sources 120, 122.

Item 130 may correspond to a wide variety of articles ranging from a conveying device like a conveyor belt on which a hologram 140 may be placed for inspection, a bank note or currency to which the hologram is attached or any other type item to which one may wish to associate a holographic image producing device for any desire reason. While the reason for association of a hologram with an item is not important to the present subject matter, such reasons may vary from authentication of the item to which the hologram is associated to purely decorative.

With further reference to FIG. 1, it will be seen that hologram 140 may include representative structural elements 142, 144, 146 that are configured in well known ways to produce a holographic image when illuminated with a particular illumination source for which the hologram is designed to function. For example, in accordance with present technology, hologram 140 is configured to produce a holographic image viewable by a human upon illumination of the hologram with ambient light such as sun light. Other humanly visible light source may, of course, be used such as incandescent and fluorescent light sources.

During an inspection process, hologram 140 may be moved past camera 112 generally in the direct of arrow 132 to provide a full scan or picture of hologram 140. Those of ordinary skill in the art should appreciate that the hologram may be stationary and the camera or a suitable mirror system along with the illumination devices moved as, for example, might be employed in a desktop flatbed scanner.

An important aspect of the present subject matter is that hologram 140 is constructed to produce a holographic image perceivable by humans as the hologram is illuminated by visible light. The inspection of hologram 140 in accordance with present technology is performed, however, using light sources that are not necessarily humanly perceivable. By illuminating hologram 140 with humanly non-perceivable sources, hologram 140 does not interact with the sources to produce the interference patterns necessary to produce a humanly perceivable image. In this manner CCD 112 may produce signals indicative of the actual structure of the hologram without including signals produced by interference patterns as would be,produced if illumination came from a visually perceivable light source for which the hologram was design to produce a humanly perceivable holographic image.

With reference now to FIG. 2, there is illustrated a flow chart representation of a method of inspecting holograms in accordance with present technology. As illustrated in flow chart 200, in step, 202 at least a portion of a hologram is illuminated with ultra-violet (UV) light. As previously discussed with respect to FIG. 1, such illumination may be provided by one or more LEDs.

At step 204 image data is collected. Data may be collected by collecting illumination radiation scattered from the hologram by any suitable means. In an exemplary embodiment, scattered radiation may be collected using a charge-coupled device (CCD). The data collected by the CCD device produces an electronic image of the holographic structure using well-known principles that may be sent to a suitably programmed computer.

At step 206, data sent from the CCD device to the computer is evaluated to determine structural characteristics of the hologram. In particular, the computer program evaluates the structural integrity of the hologram. Determination of structural integrity may be made in a number of ways. In an exemplary methodology, the collected structural image data may be compared to similarly collected data from a master hologram. In alternative embodiments, the collected structural image data may be compared to a previously saved data file that may be stored as an electronic file on the computer used for the evaluation. Alternatively such data may be stored on any suitable medium, including, but not limited to, external storage devices including hard drives, USB type thumb drives or memory sticks, CDs, floppy disks, or any other suitable machine readable storage device.

Evaluation step 206 may be performed on a suitably programmed general-purpose or special purpose computer specifically designed to perform the desired evaluation. The programming running on a general-purpose computer may include criteria for establishing whether the hologram being inspected has been formed to meet desired specifications or not. Such specifications may include predetermined tolerances or any other criteria required for the specific application to which the hologram is to be applied. Further the programming may be configured such that certain criteria may be manually or automatically adjusted depending on the exact nature of the inspection to be performed and the specific hologram being tested.

As a final portion of the evaluation of the collected structural image data, the programming may cause the computer to given an indication of the results of the evaluation. Such results may be as simple as a pass-fail analysis with suitable visual or audible indication of results or may include such information as a derived percentage of difference between the inspected hologram and the reference or master hologram or data file with numeric or other results indications that may be observed by a system operator for final determination of structural integrity.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method of inspecting a hologram, comprising:
positioning an item carrying at least one holographic structure in view of an imaging device, the holographic structure configured to generate a hologram when viewed under visible light;
illuminating at least a portion of the holographic structure with non-visible radiation;
collecting portions of the non-visible radiation scattered by the holographic structure to form an image of the holographic structure; and
evaluating the image of the holographic structure.

2. The method set forth in claim 1, wherein evaluating the image of the holographic structure comprises evaluating whether the holographic structure is formed properly.

3. The method set forth in claim 2, wherein evaluating whether the holographic structure is formed properly comprises comparing a pattern in the image to a master pattern.

4. The method set forth in claim 1, wherein illuminating the holographic structure with non-visible radiation comprises illuminating the holographic structure with ultra-violet (UV) light.

5. The method set forth in claim 4, wherein the UV light has a peak wavelength of 395 nm.

6. The method set forth in claim 1, wherein the holographic structure is illuminated using an illumination device comprising at least one LED.

7. The method set forth in claim 1, wherein the item carrying at least one holographic structure comprises at least one piece of currency.

8. A system for inspecting a hologram, comprising:
at least one UV light source configured to illuminate at least one holographic structure carried by an item;
an imaging system configured to collect UV light from the source after the light is scattered by the holographic structure and to generate a UV image of the holographic structure from the collected scattered light; and
at least one computing device configured to analyze the UV image to determine structural characteristics of the holographic structure.

9. The system of claim 8, wherein the at least one computing device is configured to analyze the UV image in order to indicate whether the holographic structure is formed properly.

10. The system of claim 9, wherein the UV image is analyzed by comparing a pattern in the UV image to a master pattern.

11. The system of claim 8, wherein the UV light has a peak wavelength of 395 nm.

12. The system of claim 8, wherein the light source comprises at least one LED.

13. The system of claim 8, wherein the item carrying at least one holographic structure comprises currency.
